(19) United States
(12) Patent Application Publication
(10) Pub. No.: US 2007/0240095 A1
(43) Pub. Date: Oct. 11, 2007

(54) Computer product customized information programming method and system

(75) Inventors: Wh Shih, Taipei (TW); Meng-Ying Tsai, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/343,312

(22) Filed: Jan. 30, 2006

(51) Int. Cl. G06F 9/44

(52) U.S. Cl. 717/100

(57) ABSTRACT

A computer product customized information programming method and system is proposed, which is designed for use by a computer manufacturer to program customized information into customer-ordered computer products; and which is characterized by the capability of allowing the computer manufacturer to predefine a set of customized information for each particular model of customer-ordered computer product and store it in a database, such that during the programming procedure, the corresponding set of customized information can be retrieved from the database by using the computer product's SKU (Stock Keeping Unit) code as keyword and then written in a standardized data format into the BIOS of the computer product. Compared to the prior art, this feature can be implemented without using GPIO pins and allows the upgrading of customized information to be easier to carry out than prior art, and therefore can be implemented in a more cost-effective way.

### BACKGROUND OF THE INVENTION

1. Field of the Invention:

This invention relates to information technology (IT), and more particularly, to a computer product customized information programming method and system which is designed for use by a computer manufacturer who manufactures various different models of computer platforms based on different customer specifications, for the purpose of allowing the computer manufacturer to program a set of customized information into a non-volatile memory, such as BIOS (Basic Input/Output System) module, in each specific type of customer-ordered computer product.

2. Description of Related Art:

In the computer industry, it is a common practice for computer manufacturers to design and manufacture computer platforms for enterprise-level customers based on customer-supplied specifications. These custom-ordered computer platforms include, for example, network servers, network workstations, and notebook computers. Typically, these customer-ordered computer platforms would have different system configurations based on different needs from different customers. For example, different customers may request the installation of different peripheral interfaces, selected from SCSI (Small Computer System Interface), ATA (Advanced Technology Attachment), SATA (Serial ATA), NIC (Network Interface Card), to name just a few. In addition, if the customer-ordered computer platforms are network servers, these network servers are further categorized based on the demanded number of independent server units into 1U, 2U, and 5U (where U=Unit) models. Moreover, different customers may request the installation of different number of heat-dissipating fan units on their ordered network servers. For this sake, customer-ordered computer platforms are greatly diversified in specifications, and it is a common practice for computer manufacturers to assign a unique stock keeping unit (SKU) code for each specific model of computer platform that they manufacture for customers.

Since customer-ordered computer platforms are greatly diversified in specifications, the information about system configuration and on-screen logo that are to be programmed into these computer platforms are also different in contents. In practical implementation, customized information is typically programmed into BIOS (Basic Input/Output System) modules of the computer platforms, such that in actual utilization, the user can view the information about system configuration by retrieving it from the BIOS and is able to see a customer-specific logo (such as the customer's company logo) from the computer screen at startup.

Presently, a conventional method for programming customized information into computer platforms is carried out by way of a particular set of GPIO (General Purpose Input/Output) pins on BIOS chips to set a SKU code and related customized information into the computer platform. In practical applications, however, this hardware-based method has some drawbacks. First, it would use some of the GPIO pins so that these GPIO pins cannot be utilized for other purposes; and second, it would make the upgrading of the customized information more laborious and time-consuming at later times.

One solution to the foregoing problem is to devise a dedicated BIOS chip for each particular model of customer-ordered computer platform, where the dedicated BIOS chip is used to embed the customized information pertaining to the computer platform that the BIOS chip is to be mounted. One drawback to this practice, however, is that it would require the computer manufacturer to devise and make a large number of different types of BIOS chips for mounting on the various different models of customer-ordered computer platforms, and is therefore quite costly to implement.

### SUMMARY OF THE INVENTION

It is therefore an objective of this invention to provide a computer product customized information programming method and system which can be implemented without using GPIO pins.

It is another objective of this invention to provide a computer product customized information programming method and system which allows the upgrading of customized information to be easier to carry out than prior art.

It is still another objective of this invention to provide a computer product customized information programming method and system which can be implemented in a more cost-effective way than the prior art.

The computer product customized information programming method and system according to the invention is designed for use by a computer manufacturer who manufactures various different models of computer platforms based on different customer specifications, for the purpose of allowing the computer manufacturer to program a set of customized information into a non-volatile memory, such as BIOS (Basic Input/Output System) module, in each specific type of customer-ordered computer product.

The computer product customized information programming method according to the invention comprises: (1) defining a string set of customized information in relation to a stock keeping unit code of the computer product, and storing the data of the customized information string set in a database; (2) in the event of a user-operated selection of a stock keeping unit code, responding by issuing a corresponding query message; (3) responding to the query message by retrieving a corresponding string set of customized information from the database mapped to the user-selected stock keeping unit code; and (4) performing a data writing procedure to write the data of the customized information string set retrieved from the database into a non-volatile memory module in the computer product.

In architecture, the computer product customized information programming system according to the invention comprises: (a) a customized information string defining module, which is used to provide a user-operated customized information string defining function for user-operated definition of a string set of customized information in relation to a stock keeping unit code of the computer product; (b) a database module, which is used to store the data of each customized information string set and the associated stock keeping unit code of the computer product defined by the customized information string defining module; (c) a user interface module, which is used to provide a user-operated stock keeping unit code selecting function for user-selection of a stock keeping unit code in relation to the computer product to be programmed with customized information, and which is capable of responding to a user-operated stock keeping unit code selecting event by issuing a corresponding query message; (d) a database query module, which is capable of responding to the query message from the user interface module by retrieving a corresponding string set of customized information from the database module mapped to the user-selected stock keeping unit code; and (e) a data writing module, which is capable of writing the data of the customized information string set retrieved by the database query module from the database module into a non-volatile memory module in the computer product.

The computer product customized information programming method and system according to the invention is characterized by the capability of allowing the computer manufacturer to predefine a set of customized information for each particular model of customer-ordered computer product and store it in a database, such that during the programming procedure, the corresponding set of customized information can be retrieved from the database by using the computer product's SKU code as keyword and then written in a standardized data format, such as SMBIOS compliant Type 11 data format, into the BIOS module of the computer product. Compared to the prior art, the invention can be implemented without using GPIO pins and allows the upgrading of customized information to be easier to carry out than prior art. These advantages allow the invention to be implemented in a more cost-effective way than the prior art.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application and architecture of the computer product customized information programming system of the invention; and

FIG. 2 is a schematic diagram showing an example of the data structure of a table utilized by the computer product customized information programming system of the invention for shoring the mapping of SKU codes to customized information string sets

### DETAILED DESCRIPTION OF PREFERRED EMBODIMENTS

The computer product customized information programming method and system according to the invention is disclosed in full details by way of preferred embodiments in the following with reference to the accompanying drawings.

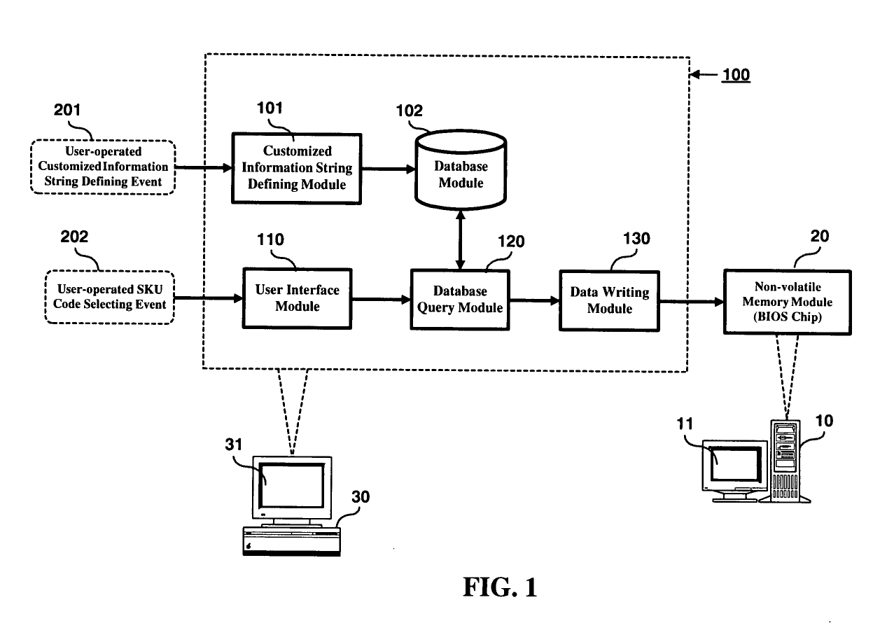

FIG. 1 is a schematic diagram showing the application and object-oriented component model of the computer product customized information programming system according to the invention (as the part enclosed in the dotted box indicated by the reference numeral 100). As shown, the computer product customized information programming system of the invention 100 is designed for use by a computer manufacturer for the purpose of allowing the computer manufacturer to program a set of customized information into a specific model of computer product 10 that the computer manufacturer designs and produces for a customer. In practical applications, for example, the computer product 10 can be a network server, a network workstation, or a notebook computer; and the content of the customized information to be programmed into the computer product 10 includes, for example, a set of system configuration data, a customer-designed logo that is to be displayed on computer screen at startup, to name a few. The customized information is typically programmed into a non-volatile memory module 20, such as a BIOS (Basic Input/Output System) flash memory module.

As shown in FIG. 1, the object-oriented component model of the computer product customized information programming system of the invention 100 comprises: (a) a customized information string defining module 101; (b) a database module 102; and (c) a user interface module 110; (d) a database query module 120; and (e) a data writing module 130. In practical implementation, the computer product customized information programming system of the invention 100 can be fully realized by computer code and installed on a process-control computer platform 30 that is used to control the process of the manufacture of the computer product 10.

Firstly, the respective attributes and behaviors of the constituent modules 101, 102 110, 120, 130 of the computer product customized information programming system of the invention 100 are described in details in the following

The customized information string defining module 101 is designed to provide a user-operated customized information string defining function for the user (i.e., computer manufacturer) to define a string set of customized information in relation to a stock keeping unit (SKU) of the computer product 10, i.e., this customized information string defining module 101 provides an on-screen user interface that allows the user to input a string set of customized information, typically in multiple strings, in advance for each of the various different models of computer products that are manufactured based on various different specifications from various different customers. When the user input a string set of customized information, it represents a user-operated customized information string defining event 201, which will cause the customized information string defining module 101 to receive the user-inputted customized information string set for storage in the database module 102. It is assumed that the user defines N string sets of customized information for N different models of computer products respectively having SKU codes SKU(1), SKU(2) . . . , and SKU(N), then these N customized information string sets will be stored respectively in N different variables denoted respectively by MULTI_STRING(1), MULTI_STRING(2) . . . , and MULTI_STRING(N).

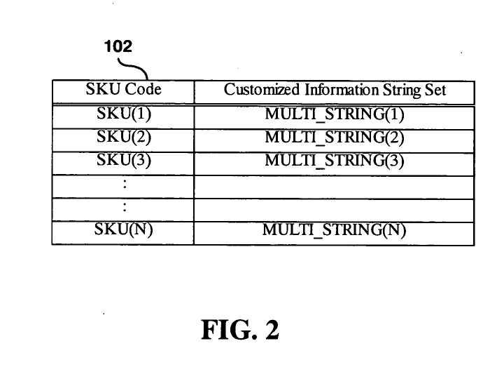

The database module 102 is used to store the data of each customized information string set with its associated SKU code defined by the above-mentioned customized information string defining module 101. FIG. 2 shows an example of the data structure of a table utilized by the database module 102 for storing the data of customized information string sets MULTI_STRING(1), MULTI_STRING(2) . . . , and MULTI_STRING(N) in relation to the SKU codes SKU(1), SKU(2) . . . , and SKU(N).

The user interface module 110 is used to provide a user-operated SKU code selecting function for the user to select a SKU code that is associated with the computer product 10, i.e., this user interface module 110 provides an on-screen user interface on the screen 31 of the process-control computer platform 30 to display a listing of all available SKU codes from which the user can select the one that is associated with the computer product 10. When the user select an SKU code, it represents a user-operated SKU code selecting event 202, which will cause the user interface module 110 to respond by issuing a corresponding query message to the database query module 120.

The database query module 120 is capable of responding to the query message from the user interface module 110 by retrieving a corresponding customized information string set from the database module 102 that is mapped to the user-selected SKU code in the user-operated SKU code selecting event 202. For example, if the user utilizes the user interface module 110 to select SKU(3), then the database query module 120 will correspondingly retrieved the associated string set MULTI_STRING(3) from the database module 102.

The data writing module 130 is capable of writing the data of the customized information string set retrieved by the database query module 120 from the database module 102 in a standardized data format into the non-volatile memory module 20 in the computer product 10. In practical implementation, for example, the standardized data format is the SMBIOS (System Management BIOS) specified Type 11 data format. Since SMBIOS is a well-known standard in the information industry, detailed description thereof will not be given in this specification.

The following is a detailed description of a practical example of the application of the computer product customized information programming system of the invention 100 during actual operation.

Before programming customized information into the computer product 10, the computer manufacturer needs first to perform a customized information string defining procedure by using the customized information string defining module 101 for defining a string set of customized information, typically in multiple strings, for each of the various different models of computer products that are to be manufactured by the computer manufacturer based on various different specifications from various different customers. Each string set of customized information includes system configuration data, a logo that is to be displayed on screen at startup, and so on. Each user-defined data of customized information and its associated SKU code are then stored into the database module 102.

In the following application example, it is assumed that the SKU code of the computer product 10 is SKU(3), and therefore based on the table shown in FIG. 3, the customized information to be programmed into the non-volatile memory module 20 of the computer product 10 is stored in MULTI_STRING(3). In this case, the computer manufacturer needs first to activate the user interface module 110 to display a listing of SKU codes from which the user can select the desired one, i.e., SKU(3). When the user selects an SKU code from the listing, it represents a user-operated SKU code selecting event 202 which will cause the user interface module 110 to respond by issuing a corresponding query message to the database query module 120. In response, the database query module 120 is activated to search through the database module 102 for the customized information string set that is mapped to the user-selected SKU code SKU(3), i.e., the MULTI_STRING(3). The found and retrieved string set MULTI_STRING(3) is then forwarded to the data writing module 130, causing the data writing module 130 to respond by writing the string data of MULTI_STRING(3) in a standardized data format, such as SMBIOS compliant Type 11 data format, into the BIOS module 20 of the computer product 10.

When the computer manufacturer ships the computer product 10 to the customer, the user of the computer product 10 can then read related system configuration data about the computer product 10 by retrieving it from the BIOS module 20, and is also able to see a logo displayed on the screen 11 of the computer product 10 at startup.

In conclusion, the invention provides a computer product customized information programming method and system for use by a computer manufacturer to program a set of customized information into a particular model of customer-ordered computer product; which is characterized by the capability of allowing the computer manufacturer to predefine a set of customized information for each particular model of customer-ordered computer product and store it in a database, such that during the programming procedure, the corresponding set of customized information can be retrieved from the database by using the computer product's SKU code as keyword and then written in a standardized data format, such as SMBIOS compliant Type 11 data format, into the BIOS module of the computer product. Compared to the prior art, the invention can be implemented without using GPIO pins and allows the upgrading of customized information to be easier to carry out than prior art. These advantages allow the invention to be implemented in a more cost-effective way than the prior art. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A computer product customized information programming method for programming a set of customized information into a computer product, which comprises;
defining a string set of customized information in relation to a stock keeping unit code of the computer product, and storing the data of the customized information string set in a database;
in the event of a user-operated selection of a stock keeping unit code, responding by issuing a corresponding query message;
responding to the query message by retrieving a corresponding string set of customized information from the database mapped to the user-selected stock keeping unit code; and
performing a data writing procedure to write the data of the customized information string set retrieved from the database into a non-volatile memory module in the computer product.

2. The computer product customized information programming method of claim 1, wherein the computer product is a network server, a network workstation, or a notebook computer.

3. The computer product customized information programming method of claim 1, 20 wherein the non-volatile memory module is a flash memory module.

4. The computer product customized information programming method of claim 1, wherein the data writing procedure utilizes SMBIOS (System Management BIOS) specified Type 11 data format for writing the customized information into the non-volatile memory module.

5. A computer product customized information programming system for programming a set of customized information into a computer product, which comprises:
a customized information string defining module, which is used to provide a user-operated customized information string defining function for user-operated definition of a string set of customized information in relation to a stock keeping unit code of the computer product;
a database module, which is used to store the data of each customized information string set and the associated stock keeping unit code of the computer product defined by the customized information string defining module;
a user interface module, which is used to provide a user-operated stock keeping unit code selecting function for user-selection of a stock keeping unit code in relation to the computer product to be programmed with customized information, and which is capable of responding to a user-operated stock keeping unit code selecting event by issuing a corresponding query message;
a database query module, which is capable of responding to the query message from the user interface module by retrieving a corresponding string set of customized information from the database module mapped to the user-selected stock keeping unit code; and
a data writing module, which is capable of writing the data of the customized information string set retrieved by the database query module from the database module into a non-volatile memory module in the computer product.

6. The computer product customized information programming system of claim 5, wherein the computer product is a network server, a network workstation, or a notebook computer.

7. The computer product customized information programming system of claim 5, wherein the non-volatile memory module is a flash memory module.

8. The computer product customized information programming system of claim 5, wherein the data writing module utilizes SMBIOS (System Management BIOS) specified Type 11 data format for writing the customized information into the non-volatile memory module.
